(19) United States
(12) Patent Application Publication
(10) Pub. No.: US 2026/0019971 A1
(43) Pub. Date: Jan. 15, 2026

(54) MANAGING SMALL DATA TRANSMISSION IN UNLICENSED RADIO FREQUENCY BAND BY WIRELESS DEVICE

(71) Applicant: Apple Inc., Cupertino, CA (US)

(72) Inventors: Jie CUI, San Jose, CA (US); Dawei ZHANG, Saratoga, CA (US); Hong HE, San Jose, CA (US); Manasa RAGHAVAN, Sunnyvale, CA (US); Qiming LI, Beijing (CN); Rolando E. BETTANCOURT ORTEGA, Munich, Bavaria-Bayern (DE); Xiang CHEN, Campbell, CA (US); Yang TANG, San Jose, CA (US); Yuexia SONG, Beijing (CN); Yuqin CHEN, Shenzhen (CN)

(21) Appl. No.: 19/101,884

(22) PCT Filed: Aug. 8, 2022
(86) PCT No.: PCT/CN2022/110809

§ 371 Date: Feb. 6, 2025

(51) Int. Cl. H04W 56/00; H04B 17/318; H04W 16/28; H04W 74/0816

(52) U.S. Cl. CPC H04W 56/0045; H04B 17/328; H04W 16/28; H04W 56/0015; H04W 74/0816

(57) ABSTRACT

This application regards managing small data transmission (SDT) in an unlicensed radio frequency band by a wireless device while in a radio resource control (RRC) inactive state. The wireless device performs a timing advance (TA) validation procedure using measured reference signal received power (RSRP) values. The wireless device transmits uplink (UL) data during a configured grant SDT (CG-SDT) occasion after DL timing synchronization is successfully acquired and after confirming a portion of the unlicensed RF band is unoccupied. The wireless device can discard or delay transmission of the UL data to a subsequent CG-SDT occasion when DL timing synchronization is not successfully acquired before the CG-SDT occasion or when encountering a listen before talk (LBT) failure indicating the CG-SDT occasion cannot be used. The wireless device can re-measure RSRP values and re-validate a TA value when a time elapsed from the previous TA validation exceeds a TA time threshold.

### FIELD

The described embodiments relate to wireless communications, including methods and apparatus to manage small data transmission (SDT) in an unlicensed radio frequency band by a wireless device.

BACKGROUND

Newer generation, e.g., fifth generation (5G) new radio (NR), cellular wireless networks that implement one or more 3^{rd} Generation Partnership Project (3GPP) 5G standards are rapidly being developed and deployed by network operators worldwide. The newer cellular wireless networks provide a range of packet-based services, with 5G technology providing increased data throughput and lower latency connections that promise enhanced mobile broadband services for wireless devices. The higher data throughput and lower latency of 5G is expected to usher in a range of new applications and services as well as improve existing ones. Communicating small amounts of data, with attendant signaling overhead while in a radio resource control (RRC) connected state with a cellular wireless network, can be inefficient for both the wireless device and the cellular wireless network. To improve signaling efficiency, a wireless device can instead transmit limited amounts of data while in a RRC inactive state with the cellular wireless network. The cellular wireless network can provide a configured grant (CG) allocating time periods for the wireless device to use for small data transmission (SDT) while in the RRC inactive state. Before sending uplink (UL) data during a CG-SDT occasion in an unlicensed radio frequency (RF) band, the wireless device attempts to acquire timing synchronization and listens to determine if the unlicensed RF band is available for transmission. Transmissions by other wireless devices in the unlicensed RF band can interfere with timing synchronization acquisition during time synchronization occasions before the CG-SDT occasion and can interfere with UL data transmission during the CG-SDT occasion. There exists a need for mechanisms for wireless devices to manage small data transmission when using an unlicensed RF band.

### SUMMARY

This application relates to wireless communications, including methods and apparatus to manage small data transmission (SDT) in a cellular unlicensed radio frequency band by a wireless device. The wireless device is configured to transmit limited amounts of data while in a radio resource control (RRC) inactive state with a cellular wireless network using an unlicensed radio frequency (RF) band. As the unlicensed RF band used by the cellular wireless network is shared with separate non-cellular wireless networks, transmission by other wireless devices in the unlicensed RF band can overlap downlink (DL) transmissions by the cellular wireless network to the wireless device and also can overlap uplink (UL) transmissions by the wireless device to the cellular wireless network. The cellular wireless network can provide a configured grant (CG) allocating time periods for small data transmission (SDT) to the wireless device in a RRC release message when transitioning the wireless device from the RRC connected state to the RRC inactive state (or while in the RRC inactive state). The RRC release message can also include a timing advance (TA) value for the wireless device to use for time alignment of UL communication transmitted to the cellular wireless network. The cellular wireless network, in some cases, can also provide a TA value to the wireless device in a medium access control (MAC) control element (CE) TA command message. The wireless device calculates a first reference signal received power (RSRP) value within a first measurement window of receipt of a most recent TA value. Later, when the wireless device determines UL data is available for CG-SDT transmission, while in the inactive state, the wireless device performs a TA validation procedure. The wireless device calculates a second RSRP value and compares the second RSRP value to the first RSRP value to determine whether the previously received TA value remains valid. After successful TA validation, the wireless device attempts to acquire timing synchronization with the cellular wireless network by receiving a DL synchronization signal block (SSB) during one or more timing synchronization occasions before a CG-SDT occasion on which to transmit a portion of the UL data. Transmission from other wireless devices that share the unlicensed RF band can interfere with transmission and/or reception of the DL SSB. The cellular wireless network can perform a listen before talk (LBT) procedure to determine whether the unlicensed RF band is unoccupied before transmitting the DL SSB to the wireless device. In some cases, DL SSB transmission may not occur or may occur but be interfered with by other wireless device transmissions. When timing synchronization is not successfully acquired before the CG-SDT occasion, the wireless device can delay transmission of a portion of the UL data intended for the CG-SDT occasion to a subsequent CG-SDT occasion or discard the portion of the UL data. In some embodiments, the wireless device must acquire timing synchronization within a time range of a CG-SDT occasion before attempting to transmit UL data during the CG-SDT occasion. When timing synchronization is not acquired before the CG-SDT occasion, the wireless device can skip the current CG-SDT occasion and attempt to acquire timing synchronization after the current CG-SDT occasion and before a subsequent CG-SDT occasion. Transmission from other wireless devices that share the unlicensed RF band can also interfere with UL data transmission, and therefore, the wireless device performs a LBT procedure before the CG-SDT occasion to determine if the unlicensed RF band is available for the UL CG-SDT transmission. When no DL LBT failure occurs (timing synchronization successfully acquired) and no UL LBT failure occurs (unlicensed RF band available for UL transmission), the wireless device transmits a portion of the UL data during the CG-SDT occasion. When an UL LBT failure occurs, the wireless device can delay transmission of the portion of the UL data to a subsequent CG-SDT occasion or discard the portion of the UL data. In some embodiments, the wireless device can re-acquire timing synchronization after the CG-SDT occasion that could not be used due to the UL LBT failure and before the subsequent CG-SDT occasion. In some embodiments, after an UL LBT failure, the wireless device discards a current portion of the UL data intended for transmission on a current CG-SDT occasion and prepares a new portion of the UL data for transmission on a subsequent CG-SDT occasion. In some embodiments, the wireless device delays the current portion of the UL data without performing a new TA validation procedure before the subsequent CG-SDT occasion. In some embodiments, before the subsequent CG-SDT occasion (and after the current CG-SDT occasion), the wireless device performs a full or partial TA validation procedure. In some embodiments, the wireless device takes one additional RSRP measurement and compares the one additional RSRP measurement with a stored RSRP measurement corresponding to the most recent TA value to determine validity of the most recent TA value. In some embodiments, the wireless device performs a full TA validation procedure, by taking two RSRP measurements and comparing them to each other to determine validity of a most recent TA value. In some embodiments, the wireless device determines whether a CG-SDT occasion is within a time range of a most recent TA validation procedure. When a time elapsed between the CG-SDT occasion, on which to next transmit UL data, and a most recent TA validation procedure exceeds a TA time threshold, the wireless device can perform a full or partial TA validation procedure to validate (or re-validate) a TA value.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1A illustrates a block diagram of different components of an exemplary system configured to perform small data transmission (SDT) communication by a wireless device, according to some embodiments.

FIG. 1B illustrates a block diagram of radio resource control (RRC) states for a wireless device, according to some embodiments.

FIG. 1C illustrates a chart of exemplary messaging between a wireless device and a cellular wireless network to perform SDT communication, according to some embodiments.

FIG. 2 illustrates a diagram of exemplary failures that can occur when performing SDT communication in an unlicensed radio frequency (RF) band, according to some embodiments.

FIGS. 3A, 3B, and 3C illustrate diagrams of exemplary mechanisms to mitigate downlink (DL) timing synchronization failures during SDT communication by a wireless device, according to some embodiments.

FIGS. 4A, 4B, and 4C illustrate diagrams of exemplary mechanisms to mitigate uplink (UL) transmission failures during SDT communication by a wireless device, according to some embodiments.

FIG. 5 illustrates a flowchart of an exemplary method to manage SDT communication by a wireless device, according to some embodiments.

FIG. 6 illustrates a flowchart of another exemplary method to manage SDT communication by a wireless device, according to some embodiments.

FIG. 7 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

This application relates to wireless communications, including methods and apparatus to manage small data transmission (SDT) in an unlicensed radio frequency band by a wireless device. The wireless device is configured to transmit limited amounts of uplink (UL) data while in a radio resource control (RRC) inactive state with a cellular wireless network using an unlicensed radio frequency (RF) band. Transmission of UL data by the wireless device while in the RRC inactive state can be more efficient than transitioning to the RRC connected state, particularly regarding signaling overhead, when only small amounts of data are available for UL transfer. Limited UL data transmission by a wireless device while in the RRC inactive state can be referred to as small data transmission (SDT). As the unlicensed RF band used by the cellular wireless network is shared with separate non-cellular wireless networks, transmission by other wireless devices in the unlicensed RF band can overlap downlink (DL) transmissions by the cellular wireless network to the wireless device and can also overlap UL transmissions by the wireless device to the cellular wireless network. Interference with DL transmission by the cellular wireless network can disrupt acquisition of timing synchronization by the wireless device, while interference with UL transmission by the wireless device can interrupt UL data communication to the cellular wireless network.

The cellular wireless network can provide to the wireless device a configured grant (CG) allocating time periods for SDT, referred to herein as CG-SDT occasions, in a RRC release message when transitioning from the RRC connected state to the RRC inactive state (or while in the RRC inactive state). The RRC release message can also include a timing advance (TA) value for the wireless device to use for aligning UL transmissions to the cellular wireless network relative to DL transmissions from the cellular wireless network. The cellular wireless network, in some cases, can also provide a TA value to the wireless device in a medium access control (MAC) control element (CE) TA command while the wireless device is in the RRC inactive state. The wireless device can use the most recently receive TA value for adjusting time alignment of UL communication to the cellular wireless network. To gauge a DL pathloss reference value, the wireless device receives and measures a reference signal transmitted by the cellular wireless network and calculates a first reference signal received power (RSRP) value, referred to herein as a RSRP1 value. The RSRP1 value can be determined by the wireless device within a first measurement window of receiving a most recent TA value from the cellular wireless network. The RSRP1 value provides a snapshot of a distance between the wireless device and a gNodeB of the cellular wireless network. Later, when the wireless device determines UL data is available for CG-SDT transmission while in the inactive state, the wireless device performs a TA validation procedure to determine whether the most recent TA value can still be considered valid to use for time alignment of UL transmissions sent to the cellular wireless network. As part of the TA validation procedure, the wireless device receives and measures another reference signal and calculates a second RSRP value, referred to herein as a RSRP2 value. The wireless device then compares the second RSRP value to the first RSRP value, e.g., by calculating a difference between RSRP1 and RSRP2 and comparing a magnitude of this difference to a CG-SDT RSRP change threshold value to determine whether the TA value is remains valid. When the TA value is valid, the wireless device continues with the SDT session. When TA validation fails, the wireless device does not initiate an SDT transmission, repeats measurement of the RSRP2 value and comparison of the change in the RSRP2 value to the RSRP1 value to determine whether the TA value is validated, after which the wireless device continues the SDT session. In some cases, when the TA value is invalid for a period of time, the wireless device waits for the cellular wireless network to initiate a new SDT session.

After successful TA validation, the wireless device attempts to acquire timing synchronization with the cellular wireless network by receiving a DL synchronization signal block (SSB) during one or more timing synchronization occasions before a CG-SDT occasion on which to transmit a portion of the UL data. Transmission from other wireless devices that share the unlicensed RF band can interfere with transmission of and/or reception of the DL SSB. The cellular wireless network can perform a listen before talk (LBT) procedure to determine whether a portion of the unlicensed RF band in which the DL SSB will occur is available for transmission. In some cases, DL SSB transmission by the cellular wireless network may not occur in one or more scheduled DL timing synchronization occasions before the CG-SDT occasion or may be interfered with by other wireless device transmissions. The wireless device may be unable to acquire timing synchronization before the CG-DTS transmission occasion occurs. When timing synchronization is not successfully acquired before the CG-SDT occasion, the wireless device can delay transmission of a portion of the UL data scheduled for transmission on the CG-SDT occasion to a subsequent CG-SDT occasion or discard the portion of the UL data. In some embodiments, the wireless device must acquire timing synchronization within a time range of the CG-SDT occasion before attempting to transmit the portion of the UL data during the CG-SDT occasion. When timing synchronization is not acquired before the CG-SDT occasion (or not within the time range of the CG-SDT occasion), the wireless device can skip the current CG-SDT occasion and attempt to acquire timing synchronization after the current CG-SDT occasion and before the subsequent CG-SDT occasion. Transmission of UL data during a CG-SDT occasion will not occur unless timing synchronization is successfully acquired by the wireless device before the CG-SDT occasion.

Transmission from other wireless devices that share the unlicensed RF band can also interfere with UL data transmission by the wireless device to the cellular wireless network. The wireless device performs a LBT procedure, before an UL CG-SDT occasion on which UL data is to be transmitted, to determine if a portion of the unlicensed RF band to be used by the wireless device for the UL CG-SDT transmission is available. When timing synchronization is successfully acquired and no UL LBT failure occurs (a relevant portion of the unlicensed RF band available for UL transmission), the wireless device transmits a first portion of UL data during the CG-SDT occasion. When an UL LBT failure occurs and the current UL CG-SDT occasion cannot be used, the wireless device can delay transmission of the first portion of the UL data to a subsequent CG-SDT occasion or discard the first portion of the UL data. In some embodiments, the wireless device can re-use previously acquired timing synchronization and re-attempt the UL CG-SDT transmission on a subsequent CG-SDT occasion. In some embodiments, the wireless device can acquire timing synchronization again before the subsequent CG-SDT occasion (and after the CG-SDT occasion that could not be used due to the UL LBT failure.) In some embodiments, after an UL LBT failure, the wireless device discards the first portion of the UL data intended for transmission on a current CG-SDT occasion and prepares a new portion of the UL data for transmission on a subsequent CG-SDT occasion.

The wireless device can, in some cases, determine whether a TA value previously validated continues to remain valid or needs to be re-validated. In some embodiments, the wireless device delays a first portion of the UL data from a current CG-SDT occasion to a subsequent CG-SDT occasion, due to a DL LBT failure that inhibited successful timing synchronization or an UL LBT failure that blocked UL data transmission, and re-attempts transmitting the first portion of the UL data during the subsequent CG-SDT occasion without performing a new TA validation procedure. In some embodiments, before the subsequent CG-SDT occasion (and after the current CG-SDT occasion), the wireless device performs a full TA validation procedure or a partial TA validation procedure. In some embodiments, the wireless device performs a full TA validation procedure by taking two separate RSRP measurements and comparing them to each other to determine validity of a most recent TA value. In some embodiments, the wireless device performs a partial TA validation procedure by taking one additional RSRP measurement and comparing the additional RSRP measurement with a stored RSRP measurement corresponding to the most recent TA value to determine validity of the most recent TA value. In some embodiments, the wireless device determines whether a CG-SDT occasion on which to send UL data is within a time range of a most recent TA validation procedure. When a time elapsed between the CG-SDT occasion, on which to next transmit UL data, and a most recent TA validation procedure exceeds a TA time threshold, the wireless device can perform a full TA validation procedure or perform a partial TA validation procedure to validate (or re-validate) a most recent TA value.

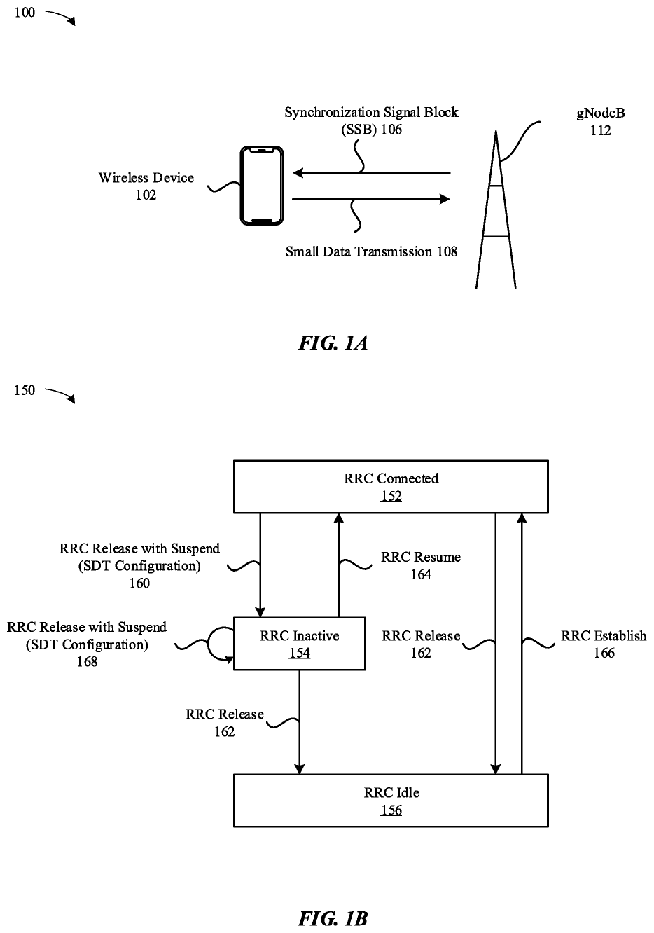

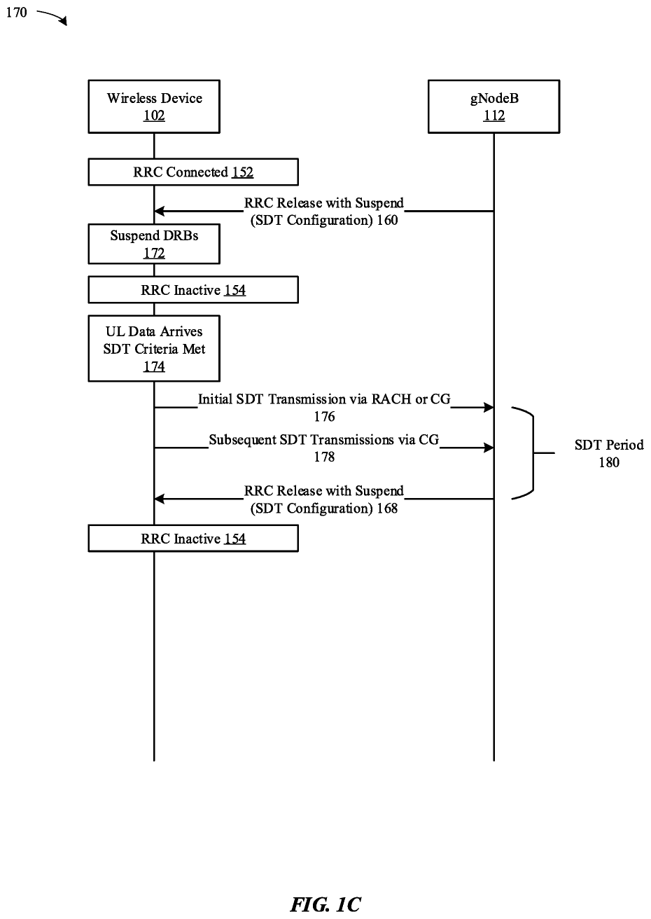

These and other embodiments are discussed below with reference to FIGS. 1 through 7; however, those skilled in the art will readily appreciate that the detailed description given herein with respect to these figures is for explanatory purposes only and should not be construed as limiting.

FIG. 1A illustrates a block diagram 100 of different components of an exemplary system configured to perform small data transmission (SDT). A wireless device 102 contains wireless circuitry that can receive cellular wireless transmissions in cellular licensed and unlicensed radio frequency (RF) bands from a cellular wireless network. A gNodeB 112 of the cellular wireless network can send reference signals, such as a synchronization signal block (SSB) 106, that the wireless device 102 can use to obtain timing and frequency synchronization for receiving communication from and for sending communication to the gNodeB 112 of the cellular wireless network. The gNodeB 112 can configure the wireless device to operate in a radio resource control (RRC) inactive state to conserve battery power and free RF resources for use by other wireless devices 102. Releases 15, 16, and 17 of 3GPP wireless communication standards introduced a small data transmission (SDT) feature to allow a wireless device 102 to transmit limited amounts of data while in the RRC inactive state without requiring the wireless device 102 to transition to a RRC connected state. Before sending an SDT 108, the wireless device 102 receives the SSB 106 to determine acquire DL timing synchronization, to allow the wireless device 102 to apply an uplink (UL) time advance (TA) adjustment relative to downlink (DL) frame boundaries to ensure proper reception of UL transmissions by the wireless device 102 to the gNodeB 112. When operating in an unlicensed RF band that is shared with other wireless devices (including non-cellular wireless devices) transmission of the SSB 106 by the gNodeB 112 may collide with transmissions of other wireless devices. The gNodeB 112 can use a listen before talk (LBT) procedure to determine whether a portion of the unlicensed RF band that the gNodeB 112 intends to use is available (free from use by other wireless devices). When the gNodeB 112 determines that the portion of the unlicensed RF band is available, the gNodeB 112 can transmit signals, e.g., the SSB 106, to the wireless device 102. When the gNodeB 112 determines that the portion of the unlicensed RF band is not available, the gNodeB 112 can refrain from transmitting to the wireless device 102 in that portion of the unlicensed RF band. Even when the gNodeB 112 successfully transmits to the wireless device 102, in some instances, other wireless devices can also transmit in the same portion of the unlicensed RF band causing a time-overlapping collision that can result in the wireless device 102 being unable to receive and successfully decode the SSB 106. When the wireless device 102 has successfully acquiring timing synchronization, the wireless device 102 can send UL data to the gNodeB 112 during a configured grant SDT (CG-SDT) occasion, when a portion of the unlicensed RF band is available for the wireless device 102 to use. Other wireless devices that use the unlicensed RF band can already occupy the CG-SDT occasion, and the wireless device 102 uses a LBT procedure to determine availability of the unlicensed RF band. In some cases, the wireless device 102 will be unable to use the allocated CG-SDT occasion. As discussed further herein, the wireless device 102 can use various techniques to manage SDT communication in the unlicensed RF band when encountering LBT failures in the DL direction that impacts timing acquisition and/or when encountering LBT failures in the UL direction that impacts transmission of the UL data on the CG-SDT occasions.

FIG. 1B illustrates a state transition diagram 150 for a wireless device 102. The wireless device 102 can be in a RRC idle state 156 when associated with a cellular wireless network but without an active connection for data transmission and reception. The wireless device 102 can monitor paging channels, perform cell measurements, and receive system information from the cellular wireless network while in the RRC idle state 156. The wireless device 102 can send a RRC establish 166 control message to the cellular wireless network to transition from the RRC idle state 156 to a RRC connected state 152, such as to initiate a mobile originated (MO) voice connection, to receive a mobile terminated (MT) voice connection, to receive DL data, or to send UL data. After completion of communication with the wireless device 102 while in the RRC connected state 152, the cellular wireless network can send a RRC release 162 message to return the wireless device 102 to the RRC idle state 156. When the wireless device 102 has only small amounts of UL data to transmit to the cellular wireless network, the signaling overhead to transition from the RRC idle state 156 to the RRC connected state 152 and to format and transmit the small amounts of UL data can be inefficient. Instead of sending the wireless device 102 from the RRC connected state 152 to the RRC idle state 156, the gNodeB 112 of a cellular wireless network can transition the wireless device 102 to a RRC inactive state 154 by sending a RRC release with suspend 160 command message. The RRC release with suspend 160 command message can include a SDT configuration that indicates CG-SDT occasions on which the wireless device 102 can transmit limited amounts of UL data while remaining in the RRC inactive state 154 and not requiring the wireless device 102 transition back to the RRC connected state 152 to transmit the limited amounts of UL data. The wireless device 102 can communicate UL data while in the RRC inactive state 154 using an SDT procedure on one or more CG-SDT occasions. Should the wireless device 102 require more radio resources than available via the SDT procedure, the wireless device 102 can return to the RRC connected state 152 via a RRC resume 164 command message. After completing UL data transmission via the SDT procedure, the wireless device 102 can remain in the RRC inactive state 154 after receiving an additional RRC release with suspend 168 command message from the gNodeB 112 of the cellular wireless network. The additional RRC release with suspend 168 command message can include an SDT configuration that indicates future CG-SDT occasions for the wireless device 102 to use for future small amounts of UL data. Alternatively, the wireless device 102 can transition to the RRC idle state 156 in response to a RRC release 162 command message (without suspend or SDT configuration) from the gNodeB 112 of the cellular wireless network.

FIG. 1C illustrates a diagram 170 of a SDT signaling procedure including messaging between a wireless device 102 and a gNodeB 112 of a cellular wireless network. The wireless device 102 can receive, while in a RRC connected state 152, a RRC release with suspend 160 command message from the gNodeB 112 including an SDT configuration. The wireless device 102, at 172, can suspend data radio bearers (DRBs) and transition to a RRC inactive state 154. The wireless device 102 can also suspend one or more signaling radio bearers (SRBs) while maintaining (or re-establishing) at least one SRB with the gNodeB 112 of the cellular wireless network. Within a time window of transitioning from the RRC connected state 152 to the RRC inactive state 154, the wireless device 102 can also measure and store a first reference signal received power (RSRP) value, referred to herein as RSRP1, to later use as part of a timing alignment (TA) validation procedure. At 174, the wireless device 102 determines pending UL data is available for transmission to the gNodeB 112 of the cellular wireless network and also determines that one or more SDT criteria for using the SDT procedure while in the RRC inactive state 154 are satisfied. The wireless device 102 can resume a DRB to use for SDT transmissions. At 176, the wireless device 102 sends an initial SDT transmission using a random-access channel (RACH) or via a configured grant (CG). At 178, the wireless device 102 sends additional SDT transmissions on one or more CG-SDT occasions. At the end of the SDT period 180, the gNodeB 112 sends a RRC release with suspend 168 command message to the wireless device 102, which includes another SDT configuration indicating future CG-SDT occasions for the wireless device 102 to use for future SDT transmissions while remaining in the RRC inactive state 154. Within a time window of the RRC release with suspend 168 command message, the wireless device 102 can re-measure and store an updated RSRP1 value to later use as part of a timing alignment (TA) validation procedure.

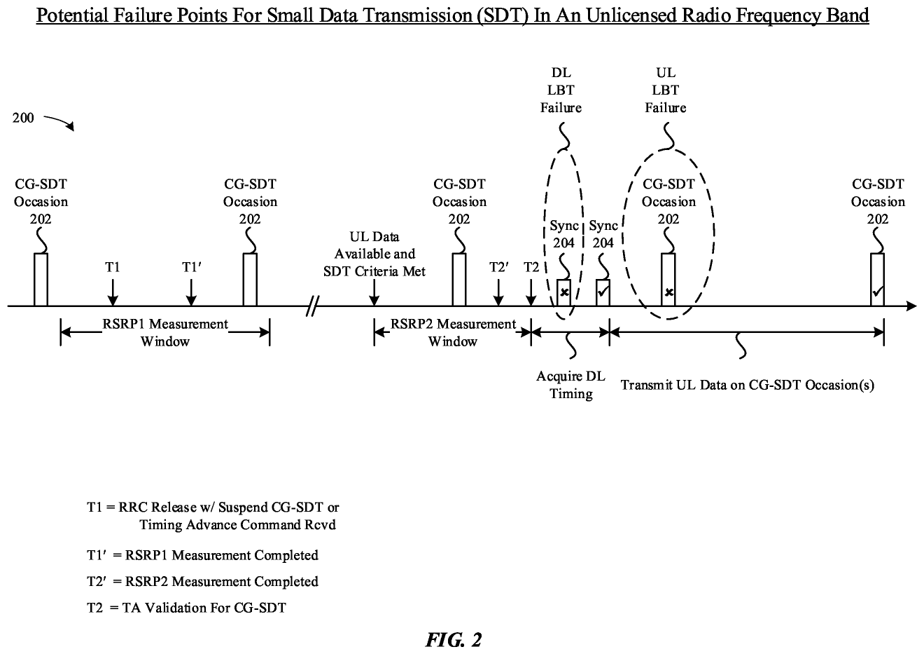

FIG. 2 illustrates a diagram 200 of potential failure points that can occur for SDT transmission in an unlicensed RF band by a wireless device 102. The wireless device 102 can be in a RRC inactive state 154 having previously received a RRC release with suspend 168 command message that includes a SDT configuration indicating CG-SDT occasions 202. The wireless device 102 completes an RSRP1 measurement at time T1′ within an RSRP1 measurement window of receipt of the RRC release with suspend 168 command message or after receipt of a timing advance (TA) medium access control (MAC) control element (CE) that included a most recent TA value for the wireless device 102 to use for aligning UL transmissions sent to the gNodeB 112 relative to DL transmissions received from the gNodeB 112. The RSRP1 value can be stored for future use by the wireless device 102 during a timing advance (TA) validation procedure. Subsequently, the wireless device 102 determines UL data suitable for SDT transmission is available and that criteria for sending the UL data via SDT mechanisms are met. The wireless device 102 can transmit on a CG-SDT occasion 202 only after successfully acquiring timing synchronization with the gNodeB 112. The wireless device 102 can perform timing synchronization acquisition after completion of a TA validation procedure. The wireless device 102 measures a second RSRP value, referred to herein as an RSRP2 value, at time T2′ within an RSRP2 measurement window before performing the TA validation procedure at time T2. The wireless device 102 performs the TA validation procedure by comparing the RSRP2 value to the previously measured and stored RSRP1 value to determine whether the RSRP has changed (increased or decreased) by more than a CG-SDT RSRP change threshold configured by the gNodeB 112. For example, the wireless device 102 can calculate a magnitude of a difference between the RSRP1 and RSRP2 values and determine whether this magnitude exceeds the CG-SDT RSRP change threshold. The RSRP values provide an indication of signal strength for signals received from the gNodeB 112, and the difference between the recently measured RSRP value, RSRP2, and the previously measured RSRP1 value can indicate whether the signal strength has changed such that the most recent TA value received from the gNodeB 112 may no longer be valid. Changes in the received signal strength based on the RSRP values can indicate a change in path loss (for signal propagation between the gNodeB 112 and the wireless device 102), which can indicate a previously received, most recent TA value may be stale (no longer considered valid).

After successfully validating the most recent TA value, the wireless device 102 can perform timing acquisition by attempting to receive from the gNodeB 112 an SSB 106 (or a relevant portion thereof) during a timing synchronization occasion 204. As the wireless device 102 and the gNodeB 112 can be communicating in an unlicensed RF band, the gNodeB 112 can perform an LBT procedure before transmitting the SSB 106 during the timing synchronization occasion 204 to determine whether the portion of the unlicensed RF band on which the gNodeB 112 intends to transmit the SSB 106 is unoccupied. A downlink (DL) LBT failure can occur on a timing synchronization occasion 204 when the unlicensed RF band is occupied by another wireless device or when transmission by another wireless device overlaps transmission of the SSB 106 and impacts successful reception and decoding of the SSB 106 during the timing synchronization occasion 204 by the wireless device 102. Multiple timing synchronization occasions 204 can be available on which to acquire DL timing synchronization before a CG-SDT occasion 202. The wireless device 102 can retry to acquire DL timing synchronization on one or more of the additional available timing synchronization occasions 204 that occur before the CG-SDT occasion 202. As shown in FIG. 2, a DL LBT failure occurs on a first timing synchronization occasion 204, but the wireless device successfully acquires DL timing on a second timing synchronization occasion 204. When the wireless device 102 is unable to acquire timing synchronization on any of the timing synchronization occasions 204 before the CG-SDT occasion 202, the wireless device 102 can discard the portion of the pending UL data or can delay transmission of the portion of the pending UL data to a subsequent CG-SDT occasion 202. In some embodiments, the wireless device 102 can be required to acquire timing synchronization successfully within a time range of the CG-SDT occasion 202 on which to attempt to transmit the portion of the pending UL data. Timing synchronization acquired too much earlier than a CG-SDT occasion 202 can be considered not to be usable for the wireless device 102, and timing synchronization may need to be re-acquired closer to the CG-SDT occasion 202 used for the UL data transmission.

After successfully acquiring DL timing, the wireless device 102 can prepare to transmit a portion of pending UL data on a next available CG-SDT occasion 202. The wireless device 102 can perform an LBT procedure before transmitting the UL data during the CG-SDT occasion 202 to determine whether a portion of the unlicensed RF band is available for transmission. An uplink (UL) LBT failure can occur on the CG-SDT occasion 202 when the unlicensed RF band is occupied by another wireless device 102. Multiple CG-SDT occasions 202 can be available for the wireless device 102 to use, and the wireless device 102, in some embodiments, can retry and successfully transmit the portion of pending UL data via a subsequent CG-SDT occasion 202. In some embodiments, the wireless device 102 discards the portion of the pending UL data when an UL LBT failure occurs. In some embodiments, the wireless device 102 delays the portion of the pending UL data to a subsequent CG-SDT occasion 202 and performs a complete TA validation procedure before the subsequent CG-SDT occasion 202. In some embodiments, the wireless device 102 delays the portion of the pending UL data to the subsequent CG-SDT occasion 202 and performs a partial TA validation procedure before the subsequent CG-SDT occasion 202. In some embodiments, the wireless device 102 delays the portion of the pending UL data to the subsequent CG-SDT occasion 202 without performing a TA validation procedure before the subsequent CG-SDT occasion 202. In some embodiments, the wireless device 102 delays the portion of the pending UL data to the subsequent CG-SDT occasion 202 and performs a partial or full TA validation procedure within a time range of the subsequent CG-SDT occasion 202.

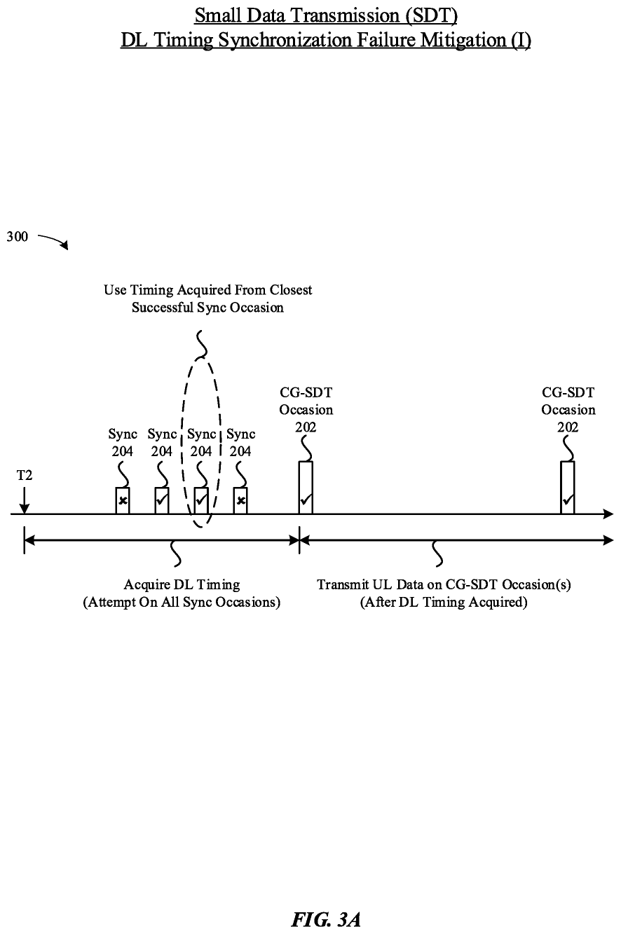

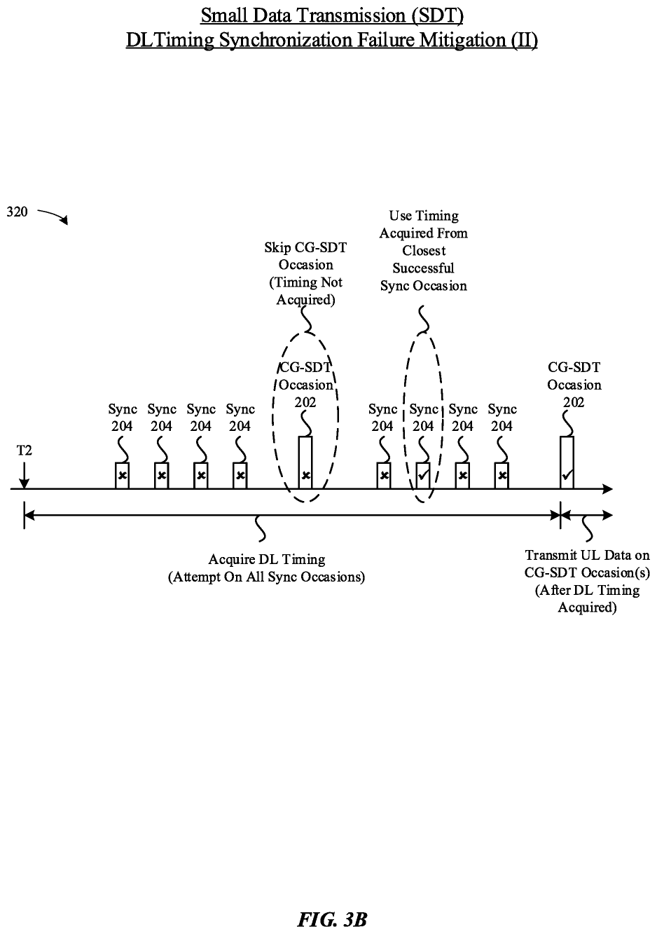

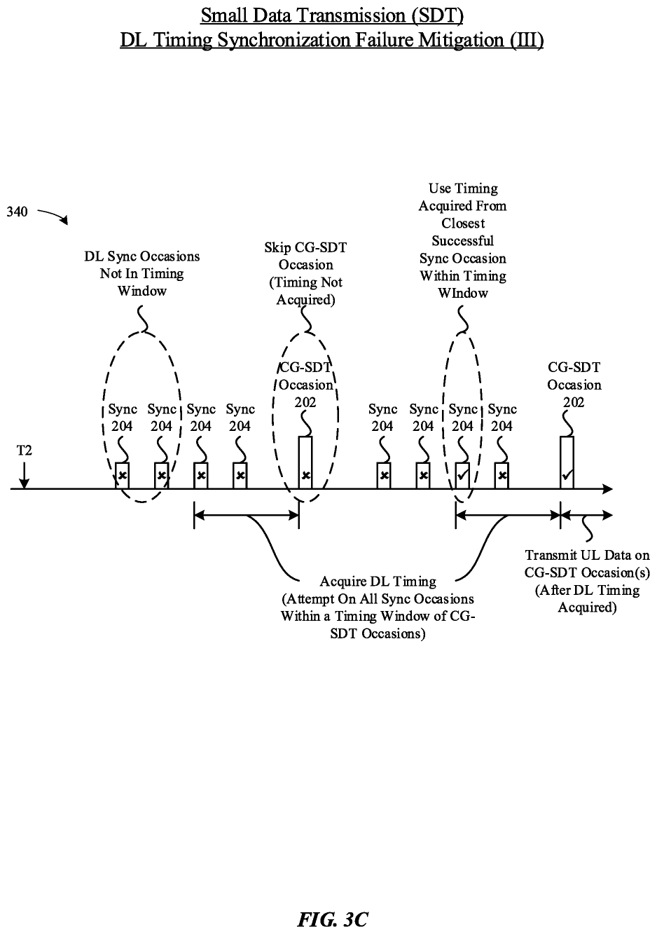

FIG. 3A illustrates a diagram 300 of an example of mitigating DL timing synchronization failures for SDT by a wireless device 102. The wireless device 102 can complete TA validation at time T2 and subsequently attempt to acquire DL timing on one or more (or all available) timing synchronization occasions 204 that occur before the CG-SDT occasion 202 (and after T2). LBT failures can occur on one or more (or all) of the timing synchronization occasions 204. In the example shown in FIG. 3A, DL timing synchronization is successfully acquired on two distinct timing synchronization occasions 204, while LBT failures occur on two other timing synchronization occasions 204. When the wireless device 102 successfully acquires DL timing on a timing synchronization occasion 204, the wireless device 102 can transmit UL data on one or more CG-SDT occasions 202 after completing successful DL timing acquisition. In some embodiments, the wireless device 102 successfully acquires DL timing on multiple timing synchronization occasions 204 before a CG-SDT occasion 202 and uses the most recently obtained DL timing acquired (from the successful timing synchronization occasion 204 closest in time to the CG-SDT occasion 202). When the wireless device 102 successfully obtains DL timing on at least one timing synchronization occasion 204, after T2 and before the CG-SDT occasion 202, the wireless device 102 can transmit on the CG-SDT occasion 202 (if the relevant portion of the unlicensed RF band is available).

FIG. 3B illustrates a diagram 320 of another example of mitigating DL timing synchronization failures for SDT by a wireless device 102. Unlike in the diagram 300 of FIG. 3A, the wireless device 102 is unable to acquiring DL timing synchronization during any of the available timing synchronization occasions 204 that occur after T2 and before a first CG-SDT occasion 202 because of DL LBT failures on all of the timing synchronization occasions 204. The wireless device 102 cannot transmit the UL data on a CG-SDT occasion 202 until DL timing synchronization has been successfully acquired, and therefore, the wireless device 102 skips the first CG-SDT occasion 202 and re-attempts to acquire DL timing synchronization using one or more timing synchronization occasions 204 that occur after the skipped CG-SDT occasion 202 and before the next CG-SDT occasion 202. In some embodiments, the wireless device 102 discards a first portion of UL data that was prepared previously for transmission on the first CG-SDT occasion 202 and prepares a second portion of UL data for the next CG-SDT occasion 202. In some embodiments, the wireless device 102 delays the first portion of UL data to the next CG-SDT occasion 202 and transmits the first portion of UL data on the next CG-SDT occasion 202 after successfully acquiring DL timing synchronization on one or more timing synchronization occasions 204 before the next CG-SDT occasion 202. If DL timing synchronization is not acquired successfully before the next CG-SDT occasion 202, the wireless device 102 can repeat the CG-SDT DL LBT failure procedure for a further CG-SDT occasion 202. The delayed first portion of UL data can be further delayed or discarded by the wireless device 102.

FIG. 3C illustrates a diagram 340 of a further example of mitigating DL timing synchronization failures for SDT by a wireless device 102. Unlike in the diagrams 300, 320 of FIGS. 3A and 3B, the wireless device 102 is required to acquire DL timing synchronization within a timing window before the CG-SDT occasion 202 (within a time range of the CG-SDT occasion 202 during which to send the UL data). In the example of diagram 340, the first two timing synchronization occasions 204 before corresponding CG-SDT occasions 202 do not occur within respective timing windows, while the second two timing synchronization occasions 204 before the corresponding CG-SDT occasions 202 do fall within the respective timing windows. The wireless device 102 can attempt to acquire DL timing synchronization on at least one (and up to all) timing synchronization occasions 204 that occur within the timing window of the corresponding CG SDT occasion 202. When DL timing synchronization is not successfully acquired on any of the timing synchronization occasions 204 within the timing window before the first CG-SDT occasion 202, the wireless device 102 can skip the first CG-SDT occasion 202 and re-attempt to acquire DL timing synchronization during one or more timing synchronization occasions 204 that occur with the timing window before the second (subsequent) CG-SDT occasion 202. In the example of diagram 340, the wireless device 102 successfully acquires DL timing during at least one timing synchronization occasion 204 that occurs within the required timing window and transmits UL data on the subsequent CG-SDT occasion 202. The UL data transmitted by the wireless device 102 on the subsequent CG-SDT occasion 202 can be either a delayed first portion of UL data or a new second portion of UL data (discarding the first portion of UL data).

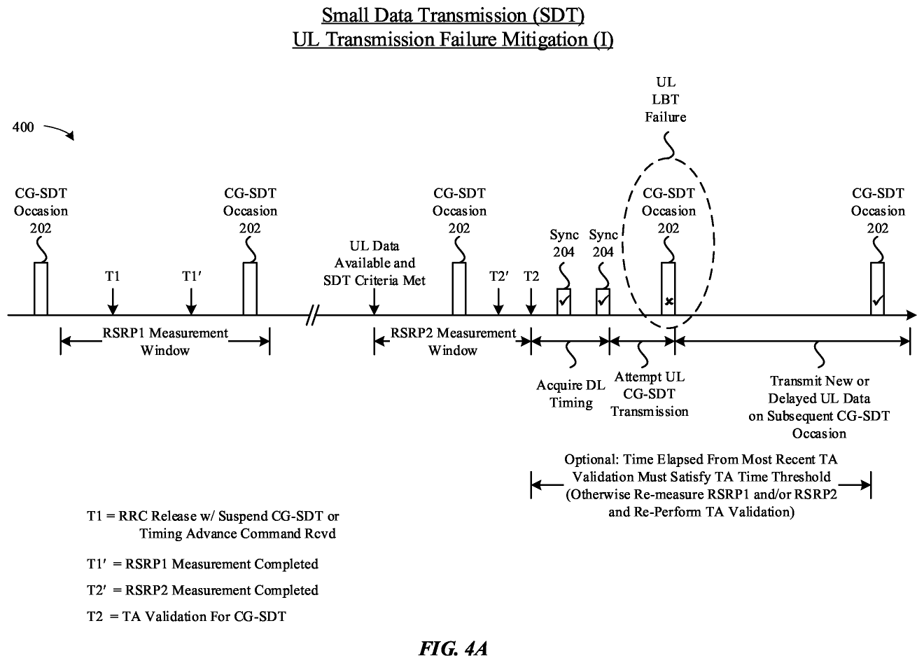

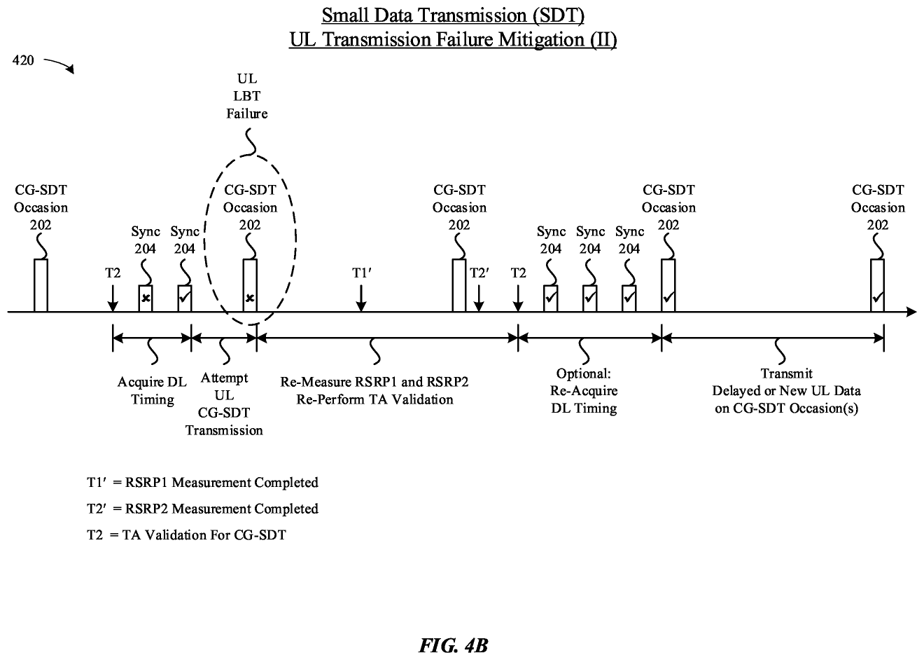

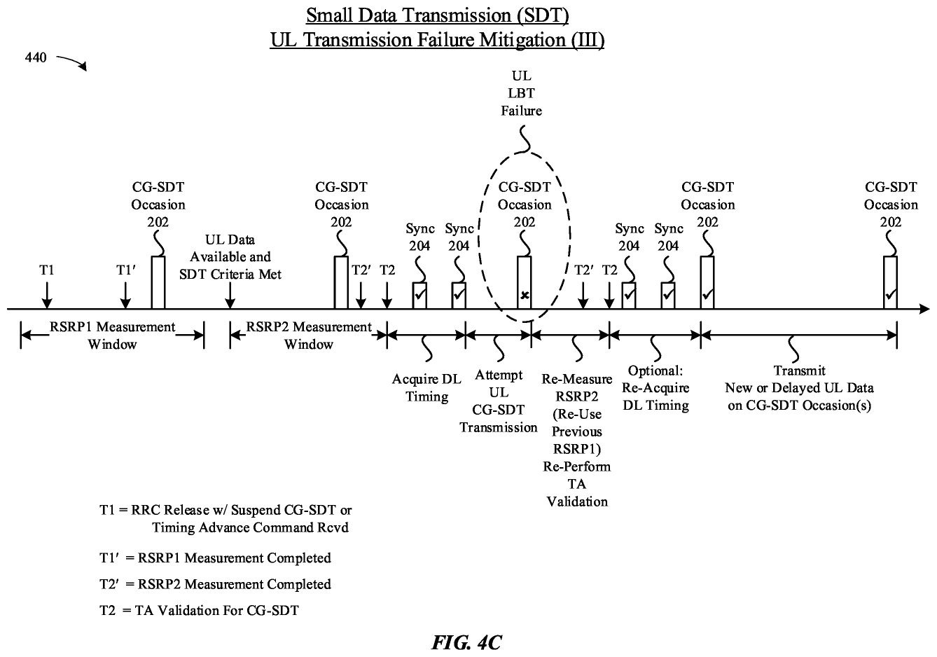

FIG. 4A illustrates a diagram 400 of an example of mitigating UL transmission failures for SDT by a wireless device 102. The wireless device 102 can complete TA validation at time T2 and subsequently successfully acquire DL timing on one or more (or all available) timing synchronization occasions 204 that occur after T2 and before a first CG-SDT occasion 202. The wireless device 102 can perform a LBT procedure and when the portion of unlicensed RF band intended for UL transmission by the wireless device 102 is not available (or is available but a collision occurs when transmitting), the wireless device 102 incurs an UL LBT failure. The wireless device 102 has several options for mitigating the UL LBT failure. The wireless device 102 can transmit delayed UL data (prepared for the first CG-SDT occasion 202) on a subsequent CG-SDT occasion or can transmit new UL data (prepared for the subsequent CG-SDT occasion 202) on the subsequent CG-SDT occasion and discard the previously prepared UL data. In some embodiments, the wireless device 102 re-uses DL timing synchronization obtained previously for the first CG-SDT occasion 202 for the subsequent CG-SDT occasion 202. In some embodiments, the wireless device 102 obtains (anew) DL timing synchronization on one or more timing synchronization occasions 204 (not shown) before the subsequent CG-SDT occasion 202. In some embodiments, the wireless device 102 transmits new or delayed UL data on the subsequent CG-SDT occasion 202 without performing TA validation again before the subsequent CG-SDT occasion 202. In some embodiments, the wireless device 102 determines whether a time elapsed from T2 (when TA validation occurred) satisfies (e.g., exceeds) a TA time threshold. When the TA time threshold is satisfied (time elapsed indicates that the previous TA validation is stale), the wireless device 102 can perform a complete TA validation procedure (re-measuring RSRP1 and RSRP2 values and validating a TA value) or perform a partial TA validation procedure (re-measuring RSRP2 and re-using the previously measured RSRP1 value and validating a TA value). The wireless device 102 measures an RSRP1 value in response to receipt of an RRC release with suspend message (including a CG-SDT) or in response to receiving a MAC CE TA command, and the wireless device 102 compares a current measured RSRP2 value (taken before the SDT transmission) to the most recently calculated (and stored) RSRP1 value to determine whether the most recent TA value is valid.

FIG. 4B illustrates a diagram 420 of another example of mitigating UL transmission failures for SDT by a wireless device 102. The wireless device 102 performs a first TA validation at time T2 and successfully acquires DL timing during a timing synchronization occasion 204 that occurs after T2 and before a first CG-SDT occasion 202. The wireless device 102 encounters an UL LBT failure at the first CG-SDT occasion 202 and re-performs a complete TA validation procedure by i) re-measuring RSRP1 at time T1′, ii) re-measuring RSRP2 at time T2′, and iii) performing the TA validation using the re-measured RSRP1 and RSRP2 values at the second time T2. After re-performing the TA validation, in some embodiments, the wireless device 102 re-acquires DL timing synchronization during one or more timing synchronization occasions 204 before the subsequent CG-SDT occasions 202. In some embodiments, a first portion of UL data intended for transmission on the first CG-SDT occasion 202 is discarded by the wireless device 102, and new (e.g., a second portion of) UL data is transmitted on the subsequent CG-SDT occasion(s) 202. In some embodiments, the first portion of UL data intended for transmission on the first CG-SDT occasion 202 is delayed and transmitted on the subsequent CG-SDT occasion 202.

FIG. 4C illustrates a diagram 440 of another example of mitigating UL transmission failures for SDT by a wireless device 102. The wireless device 102 performs a first TA validation at time T2 and successfully acquires DL timing during a timing synchronization occasion 204 that occurs after T2 and before a first CG-SDT occasion 202. The wireless device 102 encounters an UL LBT failure at the first CG-SDT occasion 202 and performs a partial TA validation procedure by i) re-measuring RSRP2 at a second time T2′, and ii) performing the TA validation at a second time T2 using the re-measured RSRP2 value (from the second time T2′) and the RSRP1 value previously measured at time T1′. After performing the partial TA validation, in some embodiments, the wireless device 102 re-acquires DL timing synchronization during one or more timing synchronization occasions 204 before the subsequent CG-SDT occasions 202. In some embodiments, a first portion of UL data intended for transmission on the first CG-SDT occasion 202 is discarded by the wireless device 102, and new (e.g., a second portion of) UL data is transmitted on the subsequent CG-SDT occasion(s) 202. In some embodiments, the first portion of UL data intended for transmission on the first CG-SDT occasion 202 is delayed and transmitted on the subsequent CG-SDT occasion 202.

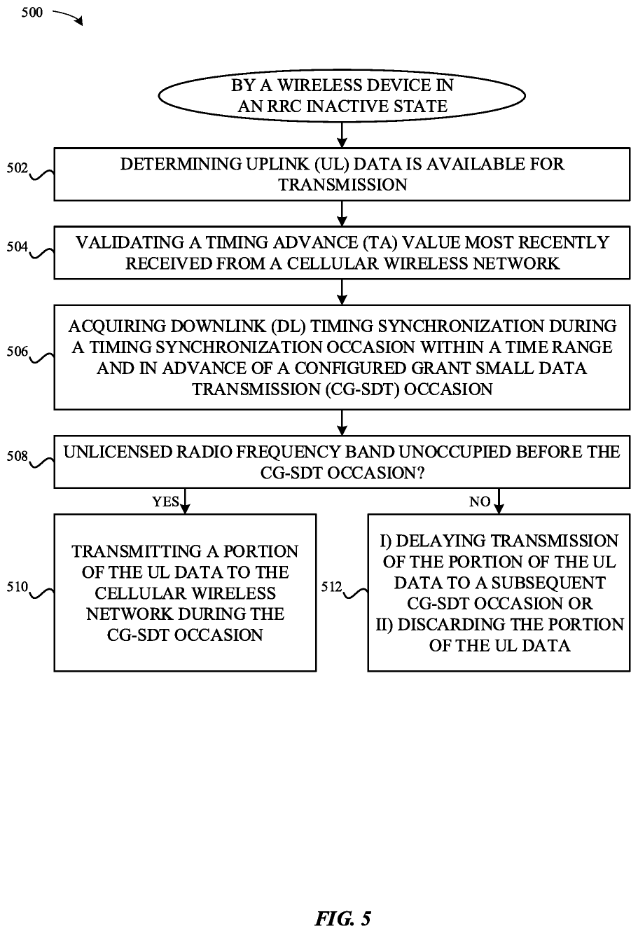

FIG. 5 illustrates a flowchart 500 of an exemplary method for managing SDT transmission by a wireless device 102 while in a RRC inactive state 154. At 502, the wireless device 102 determines whether there is pending uplink (UL) data available for transmission. At 504, the wireless device 102 validates a timing advance (TA) value most recently received from a cellular wireless network. At 506, the wireless device 102 acquires downlink (DL) timing synchronization during a timing synchronization occasion 204 within a time range and in advance of a configured grant small data transmission (CG-SDT) occasion 202. At 508, the wireless device 102 determines whether an unlicensed radio frequency (RF) band is unoccupied before the CG-SDT occasion. When the unlicensed RF band is unoccupied (and therefore available for transmission), the wireless device 102, at 510, transmits a portion of the UL data to the cellular wireless network during the CG-SDT occasion 202. When the unlicensed RF band is occupied (and therefore not available for transmission), the wireless device 102, at 512, either delays transmission of the portion of UL data to a subsequent CG-SDT occasion 202 or discards the portion of the UL data.

In some embodiments, after delaying transmission of the portion of the UL data, the wireless device 102 acquires DL timing synchronization during a second DL timing synchronization occasion 204 within a second time range of the subsequent CG-SDT occasion 202, and the wireless device 102 transmits the portion of the UL data to the cellular wireless network during the subsequent CG-SDT occasion 202, when the unlicensed RF band is available for transmission. In some embodiments, the wireless device 102 determines the validity of the TA value by determining whether a most recently measured RSRP value differs by more than an RSRP change threshold from a previously measured and stored RSRP value. In some embodiments, after delaying transmission of the portion of the UL data, the wireless device 102 i) measures one or more RSRP values, ii) re-determines validity of the TA value most recently received from the cellular wireless network based on the one or more RSRP values, and iii) transmits the portion of the UL data to the cellular wireless network during the subsequent CG-SDT occasion 202, when the unlicensed RF band is available for transmission. In some embodiments, the one or more RSRP values includes only a single RSRP value, and the wireless device 102 re-determines the validity of the TA value by determining whether the single RSRP value differs by more than an RSRP change threshold from a previously measured and stored RSRP value. In some embodiments, the one or more RSRP values include a first RSRP value and a second RSRP value measured after the first RSRP value, and the wireless device 102 re-determines validity of the TA value by determining whether the second RSRP value differs by more than an RSRP change threshold from the first RSRP value. In some embodiments, after discarding the portion of the UL data, the wireless device 102 i) acquires DL timing synchronization during a second DL timing synchronization occasion within a second time range of the subsequent CG-SDT occasion 202 and ii) transmits a second portion of the UL data to the cellular wireless network during the subsequent CG-SDT occasion 202 when the unlicensed RF band is available for transmission.

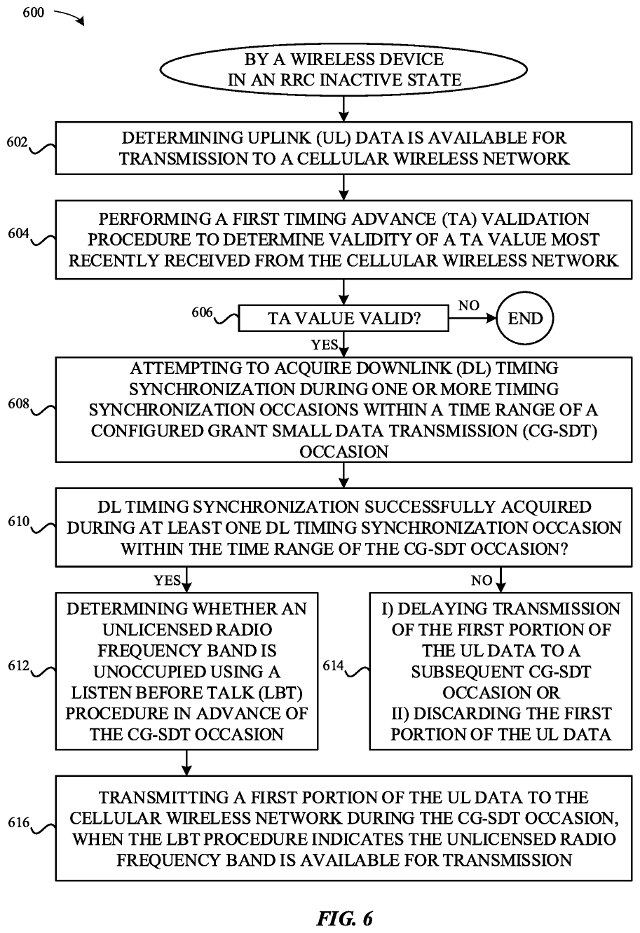

FIG. 6 illustrates a flowchart 600 of another exemplary method for managing SDT transmission by a wireless device 102 while in a RRC inactive state 154. At 602, the wireless device 102 determines UL data is available for transmission to a cellular wireless network. At 604, the wireless device 102 performs a first TA validation procedure to determine validity of a TA value most recently received from the cellular wireless network. At 606, the wireless device 102 determines (based on the TA validation procedure) whether the most recently received TA value is valid. When the most recently received TA value is invalid, the method ends. When the most recently received TA value is valid, the wireless device 102, at 608, attempts to acquire DL timing synchronization during one or more timing synchronization occasions 204 within a time range of a CG-SDT occasion 202. At 610, the wireless device 102 determines whether DL timing synchronization was successfully acquired during at least one DL timing synchronization occasion 204 within the time range of the CG-SDT occasion 202. When DL timing synchronization was successfully acquired within the time range of the CG-SDT occasion 202, the wireless device 102, at 612, determines whether an unlicensed RF band is unoccupied using a LBT procedure in advance of the CG-SDT occasion 202. At 616, the wireless device 102 transmits a first portion of the UL data to the cellular wireless network during the CG-SDT occasion 202, when the LBT procedure indicates the unlicensed RF band is available for transmission. When DL timing synchronization was not successfully acquired with the time range of the CG-SDT occasion 202, the wireless device 102, at 614, either delays transmission of the first portion of the UL data to a subsequent CG-SDT occasion 202 or discards the first portion of the UL data.

In some embodiments, when the TA value is determined to be valid and DL timing synchronization is successfully acquired during at least one DL timing synchronization occasion 204 in advance of and not within the time range of the CG-SDT occasion 202, the wireless device 102 determines whether the unlicensed RF band is unoccupied using the LBT procedure in advance of the CG-SDT occasion 202, and transmits the first portion of the UL data to the cellular wireless network during the CG-SDT occasion 202, when the LBT procedure indicates that the unlicensed RF band is available for transmission. In some embodiments, after delaying the first portion of the UL data to the subsequent CG-SDT occasion 202, the wireless device 102 determines whether the unlicensed RF band is unoccupied using the LBT procedure in advance of the subsequent CG-SDT occasion 202, and the wireless device 102 transmits the first portion of the UL data to the cellular wireless network during the subsequent CG-SDT occasion 202, when the LBT procedure indicates that the unlicensed RF band is available for transmission. In some embodiments, after discarding the first portion of the UL data, the wireless device 102, determines whether the unlicensed radio frequency band is unoccupied using the LBT procedure in advance of the subsequent CG-SDT occasion 202, and the wireless device 102 transmits a second portion of the UL data to the cellular wireless network during the subsequent CG-SDT occasion 202, when the LBT procedure indicates the unlicensed radio frequency band is available for transmission. In some embodiments, after discarding the first portion of the UL data, the wireless device 102 performs a second TA validation procedure to re-determine validity of the TA value most recently received from the cellular wireless network. When the TA value is re-determined to be valid, the wireless device 102 determines whether the unlicensed RF band is unoccupied using the LBT procedure in advance of the subsequent CG-SDT occasion 202, and the wireless device 102 transmits a second portion of the UL data to the cellular wireless network during the subsequent CG-SDT occasion 202, when the LBT procedure indicates the unlicensed radio frequency band is available for transmission. In some embodiments, when DL timing synchronization is successfully acquired during two or more DL timing synchronization occasions 204 in advance of the CG-SDT occasion 202, the wireless device 102 uses the DL timing synchronization acquired from the DL timing synchronization occasion 204 closest in time to the CG-SDT occasion 202. In some embodiments, the wireless device 102 transmits one or more portions of the UL data on one or more CG-SDT occasions 202 after successfully acquiring DL timing synchronization during at least one DL timing synchronization occasion 204 in advance of the one or more CG-SDT occasions 202. In some embodiments, the wireless device 102 transmits one or more portions of the UL data on one or more CG-SDT occasions 202 that occur within a TA time range of the first TA validation procedure after successfully acquiring DL timing synchronization during at least one DL timing synchronization occasion 204 in advance of the one or more CG-SDT occasions 202. In some embodiments, the wireless device 102 performs the first TA validation procedure by determining whether a magnitude of a difference between a current reference signal received power (RSRP) value and a previously stored RSRP value satisfies an RSRP change threshold. In some embodiments, the wireless device 102 performs a second TA validation procedure to re-determine validity of the TA value most recently received from the cellular wireless network when time elapsed after the first TA validation procedure satisfies a TA time threshold. In some embodiments, the wireless device 102 transmits one or more portions of the UL data on one or more CG-SDT occasions 202 that occur within the TA time range of the second TA validation procedure after successfully acquiring DL timing synchronization during at least one DL timing synchronization occasion 204 in advance of the one or more CG-SDT occasions 202. In some embodiments, the wireless device 102 performs the second TA validation procedure by determining a current reference signal received power (RSRP) value, and determining whether a magnitude of a difference between the current RSRP value and a previously stored RSRP value satisfies an RSRP change threshold. In some embodiments, the wireless device 102 performs the second TA validation procedure by i) determining a first reference signal received power (RSRP) value, ii) determining a second RSRP value after determination of the first RSRP value, and iii) determining whether a magnitude of a difference between the second RSRP value and the first RSRP value satisfies an RSRP change threshold.

### Representative Exemplary Apparatus

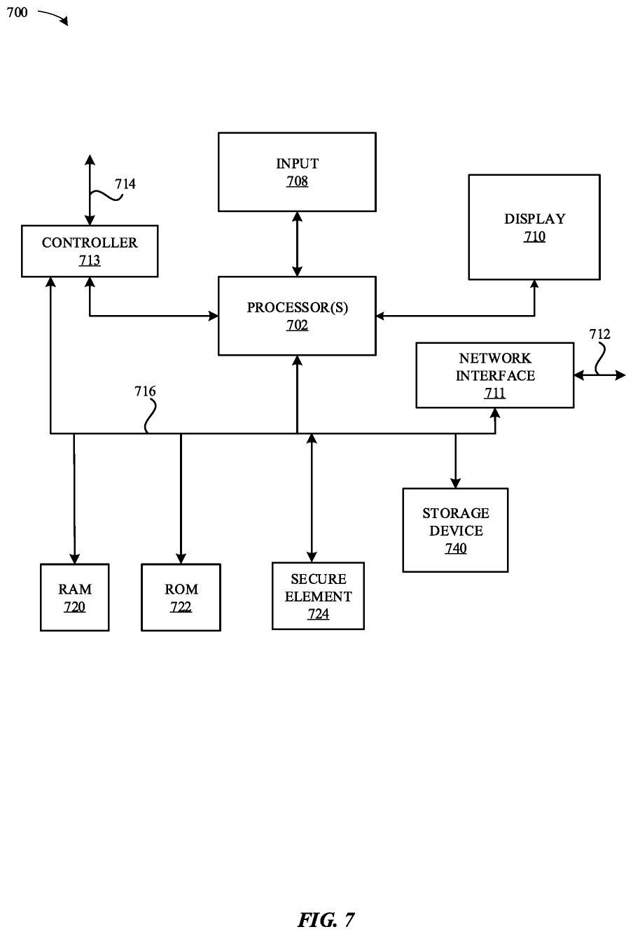

FIG. 7 illustrates in block diagram format an exemplary computing device 700 that can be used to implement the various components and techniques described herein, according to some embodiments. In particular, the detailed view of the exemplary computing device 700 illustrates various components that can be included in a wireless device 102. As shown in FIG. 7, the computing device 700 can include one or more processors 702 that represent microprocessors or controllers for controlling the overall operation of computing device 700. In some embodiments, the computing device 700 can also include a user input device 708 that allows a user of the computing device 700 to interact with the computing device 700. For example, in some embodiments, the user input device 708 can take a variety of forms, such as a button, keypad, dial, touch screen, audio input interface, visual/image capture input interface, input in the form of sensor data, etc. In some embodiments, the computing device 700 can include a display 710 (screen display) that can be controlled by the processor(s) 702 to display information to the user (for example, information relating to incoming, outgoing, or active communication sessions). A data bus 716 can facilitate data transfer between at least a storage device 740, the processor(s) 702, and a controller 713. The controller 713 can be used to interface with and control different equipment through an equipment control bus 714. The computing device 700 can also include a network/bus interface 711 that couples to a data link 712. In the case of a wireless connection, the network/bus interface 711 can include wireless circuitry, such as a wireless transceiver and/or baseband processor. The computing device 700 can also include a secure element 724. The secure element 724 can include an eUICC.

The computing device 700 also includes a storage device 740, which can include a single storage or a plurality of storages (e.g., hard drives), and includes a storage management module that manages one or more partitions within the storage device 740. In some embodiments, storage device 740 can include flash memory, semiconductor (solid state) memory or the like. The computing device 700 can also include a Random-Access Memory (RAM) 720 and a Read-Only Memory (ROM) 722. The ROM 722 can store programs, utilities or processes to be executed in a non-volatile manner. The RAM 720 can provide volatile data storage, and stores instructions related to the operation of the computing device 700.

### Wireless Terminology

In accordance with various embodiments described herein, the terms “wireless communication device,” “wireless device,” “mobile device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) LTE, LTE Advanced (LTE-A), 5G, and/or 5G-Advanced or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of

Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode user equipment (UE) can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when 5G, LTE and LTE-A networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A method for managing a small data transmission (SDT) by a wireless device using an unlicensed radio frequency band of a cellular wireless network, the method comprising:
by the wireless device while in an inactive state:
determining uplink (UL) data is available for transmission to the cellular wireless network;
performing a first timing advance (TA) validation procedure to determine validity of a TA value most recently received from the cellular wireless network;
when the TA value is determined to be valid:
attempting to acquire downlink (DL) timing synchronization during one or more timing synchronization occasions within a time range of a configured grant SDT (CG-SDT) occasion;
when DL timing synchronization is successfully acquired during at least one DL timing synchronization occasion within the time range of the CG-SDT occasion:
determining whether the unlicensed radio frequency band is unoccupied using a listen before talk (LBT) procedure in advance of the CG-SDT occasion; and
transmitting a first portion of the UL data to the cellular wireless network during the CG-SDT occasion, when the LBT procedure indicates the unlicensed radio frequency band is available for transmission; and
when acquisition of DL timing synchronization fails in all DL timing synchronization occasions in advance of the CG-SDT occasion:
i) delaying transmission of the first portion of the UL data to a subsequent CG-SDT occasion, or
ii) discarding the first portion of the UL data.

2. The method of claim 1, further comprising:
by the wireless device while in the inactive state:
when the TA value is determined to be valid and DL timing synchronization is successfully acquired during at least one DL timing synchronization occasion in advance of and not within the time range of the CG-SDT occasion:
determining whether the unlicensed radio frequency band is unoccupied using the LBT procedure in advance of the CG-SDT occasion; and
transmitting the first portion of the UL data to the cellular wireless network during the CG-SDT occasion, when the LBT procedure indicates the unlicensed radio frequency band is available for transmission.

3. The method of claim 1, further comprising:
by the wireless device while in the inactive state:
after delaying the first portion of the UL data to the subsequent CG-SDT occasion:
determining whether the unlicensed radio frequency band is unoccupied using the LBT procedure in advance of the subsequent CG-SDT occasion; and
transmitting the first portion of the UL data to the cellular wireless network during the subsequent CG-SDT occasion, when the LBT procedure indicates the unlicensed radio frequency band is available for transmission.

4. The method of claim 1, further comprising:
by the wireless device while in the inactive state:
after discarding the first portion of the UL data:
determining whether the unlicensed radio frequency band is unoccupied using the LBT procedure in advance of the subsequent CG-SDT occasion; and
transmitting a second portion of the UL data to the cellular wireless network during the subsequent CG-SDT occasion, when the LBT procedure indicates the unlicensed radio frequency band is available for transmission.

5. The method of claim 1, further comprising:
by the wireless device while in the inactive state:
after discarding the first portion of the UL data:
performing a second TA validation procedure to re-determine validity of the TA value most recently received from the cellular wireless network; and
when the TA value is re-determined to be valid:
determining whether the unlicensed radio frequency band is unoccupied using the LBT procedure in advance of the subsequent CG-SDT occasion; and
transmitting a second portion of the UL data to the cellular wireless network during the subsequent CG-SDT occasion, when the LBT procedure indicates the unlicensed radio frequency band is available for transmission.

6. The method of claim 1, further comprising:
by the wireless device while in the inactive state:
when DL timing synchronization is successfully acquired during two or more DL timing synchronization occasions in advance of the CG-SDT occasion, using the DL timing synchronization acquired from the DL timing synchronization occasion closest in time to the CG-SDT occasion.

7. The method of claim 1, further comprising:
by the wireless device while in the inactive state:
transmitting one or more portions of the UL data on one or more CG-SDT occasions after successfully acquiring DL timing synchronization during at least one DL timing synchronization occasion in advance of the one or more CG-SDT occasions.

8. The method of claim 1, further comprising:
by the wireless device while in the inactive state:
transmitting one or more portions of the UL data on one or more CG-SDT occasions that occur within a TA time range of the first TA validation procedure after successfully acquiring DL timing synchronization during at least one DL timing synchronization occasion in advance of the one or more CG-SDT occasions.

9. The method of claim 1, wherein performing the first TA validation procedure comprises determining whether a magnitude of a difference between a current reference signal received power (RSRP) value and a previously stored RSRP value satisfies an RSRP change threshold.

10. The method of claim 1, further comprising:
by the wireless device while in the inactive state:
performing a second TA validation procedure to re-determine validity of the TA value most recently received from the cellular wireless network when time elapsed after the first TA validation procedure satisfies a TA time threshold; and
transmitting one or more portions of the UL data on one or more CG-SDT occasions that occur within a TA time range of the second TA validation procedure after successfully acquiring DL timing synchronization during at least one DL timing synchronization occasion in advance of the one or more CG-SDT occasions.

11. The method of claim 10, wherein performing the second TA validation procedure comprises:
determining a current reference signal received power (RSRP) value; and
determining whether a magnitude of a difference between the current RSRP value and a previously stored RSRP value satisfies an RSRP change threshold.

12. The method of claim 10, wherein performing the second TA validation procedure comprises:
determining a first reference signal received power (RSRP) value;
determining a second RSRP value after determination of the first RSRP value; and
determining whether a magnitude of a difference between the second RSRP value and the first RSRP value satisfies an RSRP change threshold.

13. A method for managing a small data transmission (SDT) by a wireless device using an unlicensed radio frequency band of a cellular wireless network, the method comprising:
by the wireless device while in an inactive state:
determining uplink (UL) data is available for transmission to the cellular wireless network;
determining validity of a timing advance (TA) value most recently received from the cellular wireless network;
acquiring downlink (DL) timing synchronization during a DL timing synchronization occasion within a time range of a configured grant SDT (CG-SDT) occasion;
transmitting a portion of the UL data to the cellular wireless network during the CG-SDT occasion, when the unlicensed radio frequency band is available for transmission;
when the unlicensed radio frequency band is not available for transmission:
i) delaying transmission of the portion of the UL data to a subsequent CG-SDT occasion, or
ii) discarding the portion of the UL data.

14. The method of claim 13, further comprising:
by the wireless device while in the inactive state:
after delaying transmission of the portion of the UL data:
acquiring downlink (DL) timing synchronization during a second DL timing synchronization occasion within a second time range of the subsequent CG-SDT occasion; and
transmitting the portion of the UL data to the cellular wireless network during the subsequent CG-SDT occasion, when the unlicensed radio frequency band is available for transmission.

15. The method of claim 13, wherein determining the validity of the TA value comprises determining whether a most recently measured RSRP value differs by more than an RSRP change threshold from a previously measured and stored RSRP value.

16. The method of claim 13, further comprising:
by the wireless device while in the inactive state:
after delaying transmission of the portion of the UL data:
measuring one or more reference signal received power (RSRP) values;
re-determining validity of the TA value most recently received from the cellular wireless network based on the one or more RSRP values; and
transmitting the portion of the UL data to the cellular wireless network during the subsequent CG-SDT occasion, when the unlicensed radio frequency band is available for transmission.

17. The method of claim 15, wherein:
the one or more RSRP values comprises only a single RSRP value; and
re-determining the validity of the TA value comprises determining whether the single RSRP value differs by more than an RSRP change threshold from a previously measured and stored RSRP value.

18. The method of claim 15, wherein:
the one or more RSRP values comprise a first RSRP value and a second RSRP value measured after the first RSRP value; and
re-determining the validity of the TA value comprises determining whether the second RSRP value differs by more than an RSRP change threshold from the first RSRP value.

19. The method of claim 13, further comprising:
by the wireless device while in the inactive state:
after discarding the portion of the UL data:
acquiring downlink (DL) timing synchronization during a second DL timing synchronization occasion within a second time range of the subsequent CG-SDT occasion; and
transmitting a second portion of the UL data to the cellular wireless network during the subsequent CG-SDT occasion, when the unlicensed radio frequency band is available for transmission.

20. An apparatus configurable for operation in a wireless device, the apparatus comprising one or more processors coupled to a memory storing instructions that, when executed by the one or more processors, configure the wireless device to manage a small data transmission (SDT) while in an inactive state using an unlicensed radio frequency band of a cellular wireless network by:
determining uplink (UL) data is available for transmission to the cellular wireless network;
performing a first timing advance (TA) validation procedure to determine validity of a TA value most recently received from the cellular wireless network;
when the TA value is determined to be valid:
attempting to acquire downlink (DL) timing synchronization during one or more timing synchronization occasions within a time range of a configured grant SDT (CG-SDT) occasion;
when DL timing synchronization is successfully acquired during at least one DL timing synchronization occasion within the time range of the CG-SDT occasion:
determining whether the unlicensed radio frequency band is unoccupied using a listen before talk (LBT) procedure in advance of the CG-SDT occasion; and
transmitting a first portion of the UL data to the cellular wireless network during the CG-SDT occasion, when the LBT procedure indicates the unlicensed radio frequency band is available for transmission; and
when acquisition of DL timing synchronization fails in all DL timing synchronization occasions in advance of the CG-SDT occasion:
i) delaying transmission of the first portion of the UL data to a subsequent CG-SDT occasion, or
ii) discarding the first portion of the UL data.

21. (canceled)

22. (canceled)
